(19) United States
(12) Patent Application Publication
(10) Pub. No.: US 2005/0165497 A1
(43) Pub. Date: Jul. 28, 2005

(54) Information apparatus having hierarchical menu items, method thereof, and program thereof

(75) Inventor: Kota Tanabe, Nagoya (JP)

Correspondence Address: STAAS & HALSEY LLP, SUITE 700, 1201 NEW YORK AVENUE, N.W., WASHINGTON, DC, 20005, US

(73) Assignee: Fujitsu Limited, Kawasaki (JP)

(21) Appl. No.: 11/082,651

(22) Filed: Mar. 18, 2005

Related U.S. Application Data
(63) Continuation of application No. PCT/JP03/01232, filed on Feb. 6, 2003.

(51) Int. Cl. G05B 11/01; G05B 15/00

(52) U.S. Cl. 700/23; 700/19; 700/20

(57) ABSTRACT

A cellular telephone (1) includes a display (2) for hierarchically spreading upper to lower concepts and successively displaying menu items deciding an operation content of the cellular telephone (1), a dial button (3) for selecting a menu item, a lock application (4) for disabling execution of the menu items selected by the dial button (3) in the order of the selection, a notification application (5) for notifying that the items have been locked, and a release application (6) for releasing the lock state of the menu items which have been execution-disabled by the lock application (4) in the order of the selection by the dial button (3).

This is a continuation of Application PCT/JP2003/001232, filed on Feb. 6, 2003.

### BACKGROUND OF THE INVENTION

1. Field of the Present Invention

The present invention relates to an information apparatus having menu items that spread hierarchically.

2. Description of the Related Art

Portable apparatuses such as a cellular phone and a PDA (Personal Digital Assistance), which have been widespread markedly in recent years, are acquiring more and more functions.

Contents of those functions are displayed on a display device (hereinafter referred to as display), which is provided in each apparatus, as menu items. The menu items to be displayed are displayed to spread the various functions hierarchically from upper concepts to lower concepts.

For example, menu items for performing setting concerning the display such as a change in display brightness, a change of a display color, and a change of a display method of the display are displayed on a first menu screen. Besides, menu items concerning sounds for setting adjustment or the like for an operation sound and an actuation sound are displayed on the first menu screen. In addition, menu items and the like concerning a clock for performing setting of time, alarm, and the like are displayed on the first menu screen.

Among those menu items, menu items grasped in terms of upper concepts such as “display”, “sound”, and “clock” are displayed on the first screen. After the item “display” is selected here, for example, the item spreads to menu items grasped in terms of lower concepts such as “brightness”, “tint”, and “display method”.

Moreover, after an item “brightness” is selected here, the item further spreads to items of contents for setting brightness of the display such as “bright” and “dark”.

Various conventional information apparatuses have a large number of menu items (functions) according to such a method.

Incidentally, in the conventional information apparatuses, plural menu items are displayed on a display. As described above, plural menu items grasped in terms of upper concepts are displayed on a first screen. An operator selects a menu item for executing a desired function from these menu items and displays menu items grasped in terms of lower concepts on the display. In other words, in order to execute a desired function, the operator has to select appropriate menu items separately in plural stages.

However, a beginner in operation, who is not accustomed to operation of an information apparatus, often has difficulty in selecting an appropriate menu item and cannot execute a desired function readily.

In addition, when the beginner in operation performs disordered operation in an attempt to execute a desired function, the beginner often cannot grasp a current operation state and cannot return the operation state to an original state.

In order to prevent such situations, conventional systems (referring to JP 3-168691 A, JP 10-161832 A, and JP 6-110639 A) have been made to disable operation of unnecessary menu items so as to prevent disordered operation.

Note that Japanese Patent Applications are as follows. The Japanese Patent Applications are “JP 2001-109713 A”, “JP 05-210474 A”, and “JP 07-175620 A”.

However, in those systems, setting for disabling execution of menu items has to be performed item by item. Thus, setting (this setting will be hereinafter referred to as lock) operation for disabling execution of menu items is complicated.

In addition, those systems do not have sufficient means for visually recognizing locked menu items. Thus, convenience of such an information apparatus tends to be low.

### SUMMARY OF THE INVENTION

Therefore, the present invention has been devised in view of the matters described above and it is an object of the present invention to provide an information apparatus that prevents wrong selection of a menu item with simple operation.

In order to attain the object, the present invention adopts unit described below. That is, the present invention includes display unit sequentially displaying menu items that spread hierarchically and determine an operation content of the information apparatus, selecting unit selecting the menu items, and lock unit disabling execution of plural menu items, which are selected by the selecting unit, collectively.

When the information apparatus is a cellular phone, the selecting unit is dial buttons or various operation buttons. When the information apparatus is a PDA, the selecting unit is operation icons for executing various functions. When the information apparatus is a personal computer, the selecting unit is a keyboard or a mouse.

In order to disable execution of menu items, a user selects menu items of lower concepts from menu items of upper concepts by a series of operation using the selecting unit.

Then, the lock unit of the present invention disables execution of the plural menu items, which are selected by the selecting unit, collectively.

In this way, since execution of continuously selected menu items can be locked collectively, it is possible to perform lock setting smoothly.

In addition, it is preferable that the lock unit of the present invention is performed by execution of predetermined menu items. Besides, the lock unit of the present invention may be executed by combining an operation content of operating unit. For example, when the selecting unit is dial buttons, in order to execute the lock unit, dial buttons of “3”, “7”, and “0” are depressed.

Moreover, the lock unit of the present invention includes notifying unit notifying that execution of menu items are disabled by the lock unit.

As this notifying unit, for example, there is unit displaying menu items execution-disabled by the lock unit on the display unit in a size smaller than a usual display state.

With such a method of display, an operator can clearly identify the locked items.

Since locked menu items are displayed in a size smaller than that of menu items that are not locked, it is possible to further display other menu items that are not locked. Consequently, it is possible to install a larger number of functions in the information apparatus.

The notifying unit of the present invention may make the execution-disabled menu items that are displayed on the display unit. This mark may be characters such as “key” or “lock” or may be a pattern in a shape of a key.

With such a method of display, an operator can clearly identify the locked items.

In addition, the notifying unit of the present invention can also change display brightness of the execution-disabled menu items that are displayed on the display unit.

For example, display brightness is lowered for locked menu items and increased for menu items that are not locked. In other words, the locked menu items displayed darkly on the display and the menu items, which are not locked, are displayed brightly on the display.

With such a method of display, an operator can clearly identify the locked items.

Moreover, the notifying unit of the present invention may change a display color of the execution-disabled menu items that are displayed on the display means.

For example, when display of menu items is in black usually, locked menu items are displayed in red.

With such a method of display, an operator can clearly identify the locked menu items visually.

The notifying unit of the present invention may display menu items other than the execution-disabled menu items that are displayed on the display unit in a size larger than a usual display size.

With such a method of display, an operator can clearly identify the locked menu items visually.

The display unit of the present invention displays menu items locked by the lock unit on the display unit as a list. According to the present invention, predetermined operation is performed by the dial buttons, the keyboard, or the like serving as the selecting unit, thereby making it possible to display only the locked items. Besides, a menu item for showing the locked menu as a list may be provided in menu items.

In all the cases, according to the present invention, an operator can check a lock state easily.

It is preferable that the present invention include releasing unit releasing lock of menu items execution-disabled by the lock unit in an order of selection by the selecting unit.

With such a constitution, it is possible to release the lock state set for the menu items with a series of operation.

Besides, the releasing unit of the present invention can display locked menu items on the display unit as a list and release the lock state of all the menu items collectively.

The present invention may include requesting unit requesting a predetermined password before execution of the lock unit.

By adding such a constitution, it is possible to prevent the lock unit from being released by unexpected operation.

Consequently, according to the present invention, it is possible to provide an information apparatus that prevents wrong selection of a menu item with simple operation.

### BRIEF DESCRIPTION OF THE DRAWINGS

FIG. 1 is an image diagram of expansion of menu items according to a first embodiment;

FIG. 2 is a hardware configuration diagram according to the first embodiment;

FIG. 3 is a flowchart showing an operation process for locking menu items according to the first embodiment;

FIG. 4 is an image diagram of the operation process for locking menu items according to the first embodiment;

FIG. 5 is a screen image diagram at the time when menu items are displayed as a list according to the first embodiment;

FIG. 6 is an image diagram of an operation process for releasing menu items according to the first embodiment;

FIG. 7 is a diagram showing notification contents of a first modification;

FIG. 8 is a hardware configuration diagram according to a second embodiment;

FIG. 9 is an image diagram of an operation process for locking menu items according to the second embodiment; and

FIG. 10 is an image diagram of an operation process for locking menu items according to the second embodiment.

### DESCRIPTION OF THE PREFERRED EMBODIMENTS

An information apparatus in embodiments of the present invention will be hereinafter explained. Note that the information apparatus in the following explanation is assumed to be a cellular phone. Accordingly, selecting means is assumed to be dial buttons and various operation buttons.

### First Embodiment

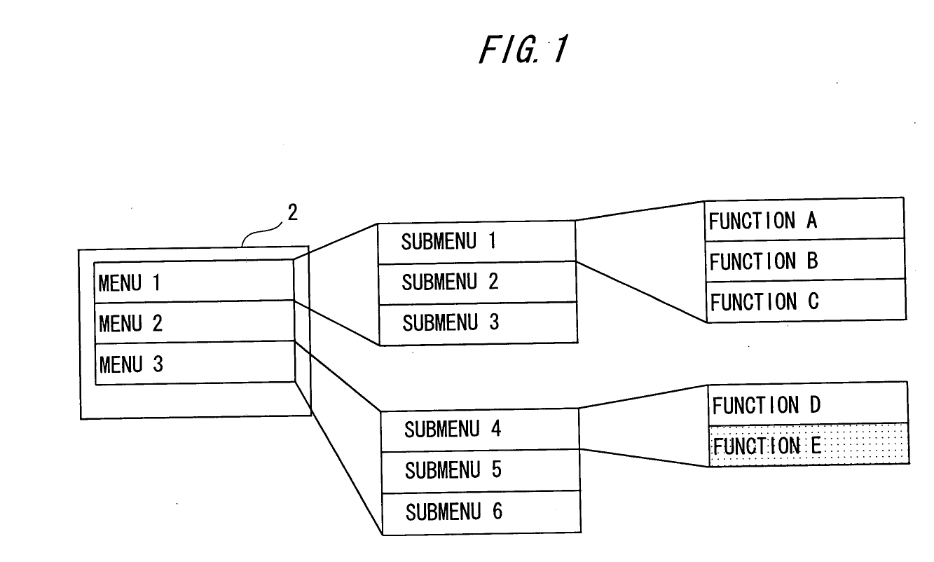

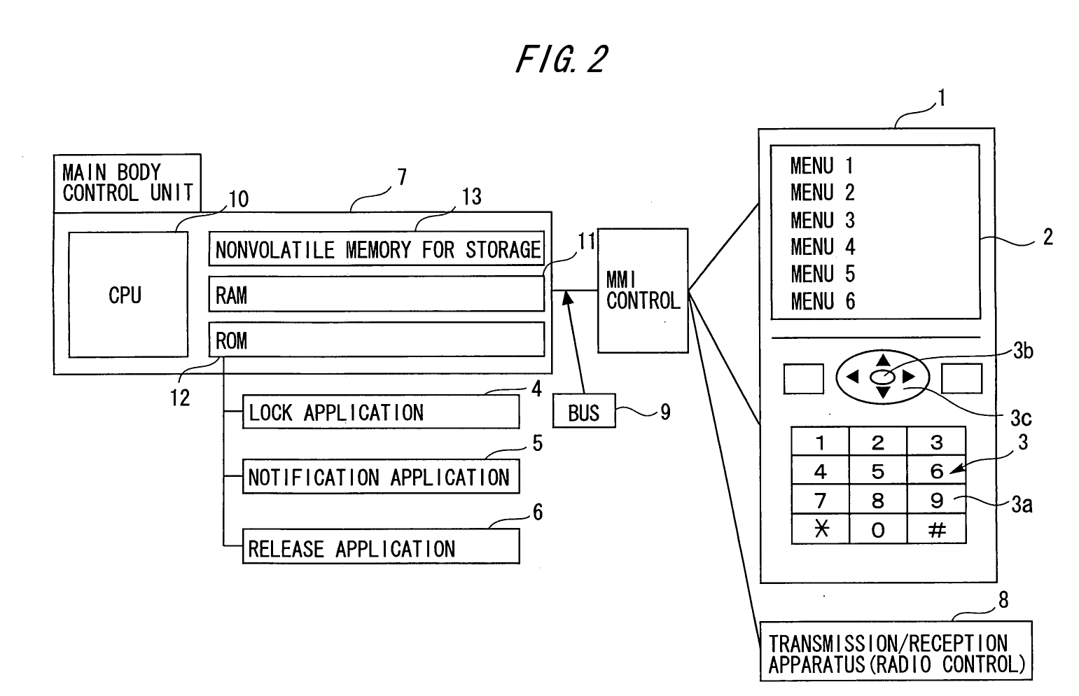

As shown in FIG. 2, a cellular phone 1 in this embodiment includes a display (display unit) 2 for sequentially displaying menu items that spread hierarchically from higher concepts to lower concepts (see FIG. 1) and determine an operation content of the cellular phone 1, dial buttons (selecting unit) 3 for selecting the menu items, a lock application (lock unit) 4 that disables execution of the menu items selected with the dial buttons 3 in an order of the selection, a notification application (notifying unit) 5 for notifying that the menu items are locked, and a release application (releasing unit) 6 that releases the lock state of the menu items execution-disabled with the lock application 4 in the order of the selection with the dial buttons 3 or the like.

The notification application 5 of the information apparatus in this embodiment affixes characters “key” to the execution-disabled menu items that are displayed on the display 2. In addition, the lock application 4 of the cellular phone 1 in this embodiment is displayed on the display 2 as a menu item.

Firstly, a hardware configuration of the cellular phone 1 in this embodiment will be explained. As shown in FIG. 2, the cellular phone 1 in this embodiment includes a main body control unit 7 that performs transmission/reception of call and various kinds of operation and controls a main body of the cellular phone 1, the dial buttons 3 for entering a telephone number and performing various kinds of operation, the display 2 that displays an operation content of the dial button 3, a transmission/reception apparatus 8 that performs transmission and reception of data and transmission/reception of calls, and a bus 9 that connects the dial buttons 3, the display 2, and the transmission/reception apparatus 8 with the main body control unit 7.

The dial buttons 3 include number buttons (hereinafter referred to as soft keys) 3a that are used in performing transmission and reception of calls, a function button 3b that is used in executing various functions, and a cursor moving button 3c that is used in moving a cursor displayed on the display 2. The cursor moving button 3c includes four switches, namely, up, down, left, and right switches. Note that, in this embodiment, depressing operation of the right switch instructs shift of a hierarchical menu to a lower layer menu and depressing operation of the left switch instructs shift to an upper layer menu.

The main body control unit 7 includes a CPU (Central Processing Unit) 10 that performs control of operation, a RAM (Random Access Memory) 11 that temporarily stores contents of control by the CPU 10, a ROM (Read Only Memory) 12 that stores applications serving as various functions of the cellular phone 1, and a nonvolatile memory 13 that stores various data.

An application (not shown) for changing brightness and colors of a screen, the lock application 4 that disables execution of menu items selected with the dial buttons 3 in an order of the selection, the notification application 5 for notifying that the menu items are locked, and the release application 6 that releases the lock state of the menu items execution-disabled with the lock application 4 in the order of the selection with the dial buttons 3 are stored in the ROM 12. These applications are executed by the CPU 10.

Various data related to the functions of the cellular phone 1 such as telephone numbers registered in a telephone directory and menu items indicating the functions of the cellular phone 1 are stored in the nonvolatile memory 13.

Described above is the hardware configuration of the cellular phone 1 in this embodiment.

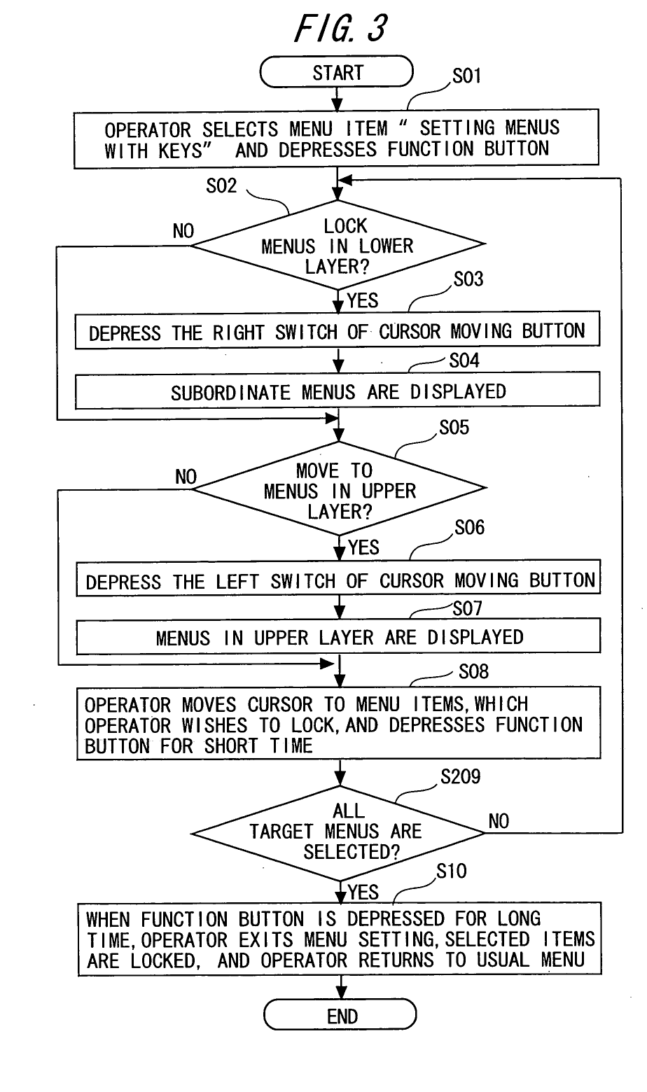

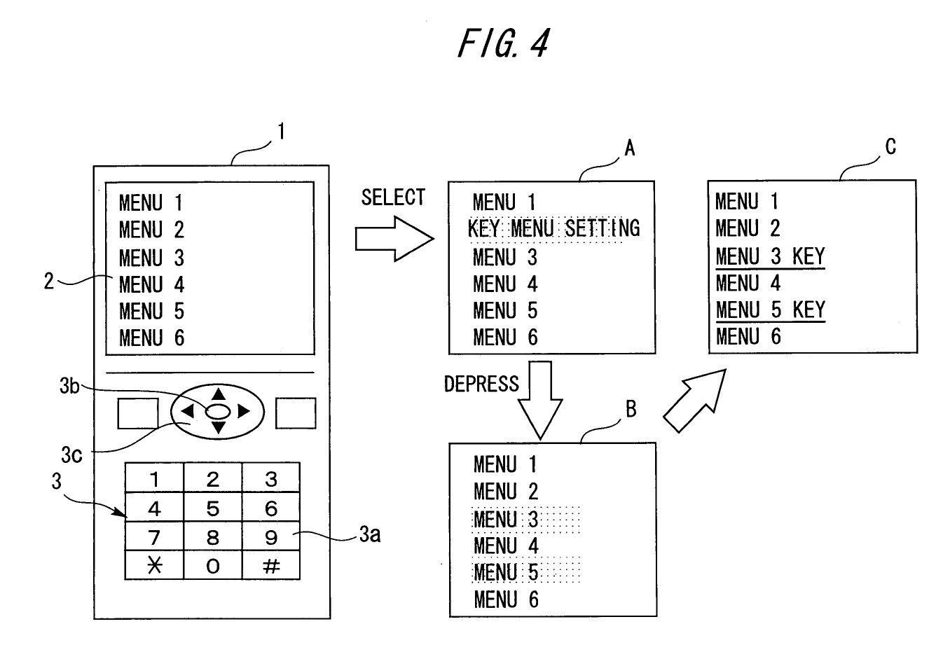

Next, an operation content of the cellular phone 1 in this embodiment will be explained. FIG. 3 is a flowchart of an operation process of the cellular phone 1 in this embodiment. FIG. 4 shows shift of display on the display 2 according to the operation process.

First, an operator selects a menu item “key menu setting” displayed on the display 2 of the cellular phone 1 shown in a screen A in FIG. 4 and depresses the function button 3b (S01). At this time, the CPU 10 extracts the lock application 4, which disables execution of menu items, from the ROM 12 and executes the lock application 4.

Next, the operator selects whether menu items in a lower layer should also be locked (S02). Here, if the menu items in the lower layer are also locked, the operator depresses the right switch of the cursor moving button 3c (S03). Then, the CPU 10 shown in FIG. 2 performs processing for displaying the menu items in the lower layer on the display 2. Consequently, the menu items in the lower layer are displayed on the display 2 (S04).

Next, the operator selects whether a cursor should be moved to menu items in an upper layer (S05). As regards this selection, for example, a case in which only locking the menu items in the upper layer is performed and a case in which locking the menu items in the lower layer is not performed may be assumed. Note that, when the operator decides that the menu items in the lower layer should not be locked in step 02, the process proceeds to step 05.

Here, when the operator wishes to move the cursor to the menu items in the upper layer, the operator depresses the left switch of the cursor moving button 3c (S06). At this point, in response to the depression of the cursor moving button 3c, the CPU 10 shown in FIG. 2 performs processing for displaying the menu items in the upper layer on the display 2. Consequently, the menu items in the upper layer (the screen A in FIG. 4) are displayed on the display 2 (S07).

On the other hand, when the cursor is not moved to the menu items in the upper layer in step 05, as shown in a screen B in FIG. 4, the operator moves the cursor to a menu item, which the operator wishes to lock, and depresses the function button 3b for a short time (S08). Note that “depressing for a short time” means operation for depressing a button and, then, releasing the depression of the button within a predetermined time period. At this point, in response to the selection of the menu item that the operator wishes to lock, the CPU 10 recognizes the selection of the menu item. Note that lock setting for the menu items in the upper layer is performed by the same operation.

Here, when selection of all the menu items is not completed (S09), the process returns to step 02 to repeat the same processing.

On the other hand, when selection of all the menu items is completed (S09), the operator depresses the function button 3b for a long time (S10). Note that “depressing for a long time” means operation for continuously depressing the button beyond the predetermined time period. At this point, the lock application 4 executes processing for disabling execution of the menu items selected with the function button 3b. Here, simultaneously with the setting for lock, the CPU 10 shown in FIG. 2 extracts the notification application 5 from the ROM 12 and executes the notification application 5.

When the locked menu items are displayed on the display 2, as shown in a screen C in FIG. 4, the notification application 5 performs processing for displaying characters “key” near the menu items.

Through the process described above, the lock setting for disabling execution of the menu items is performed.

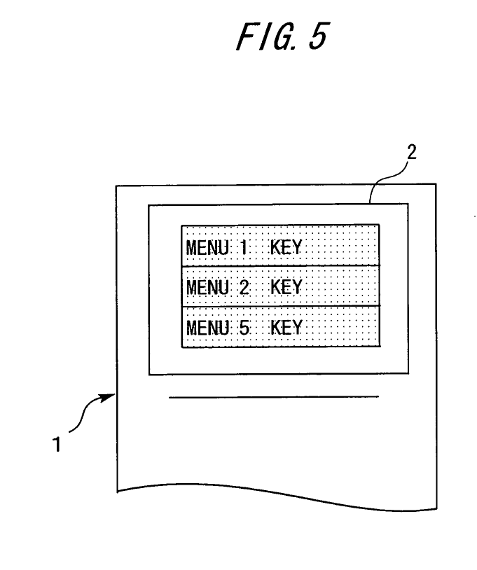

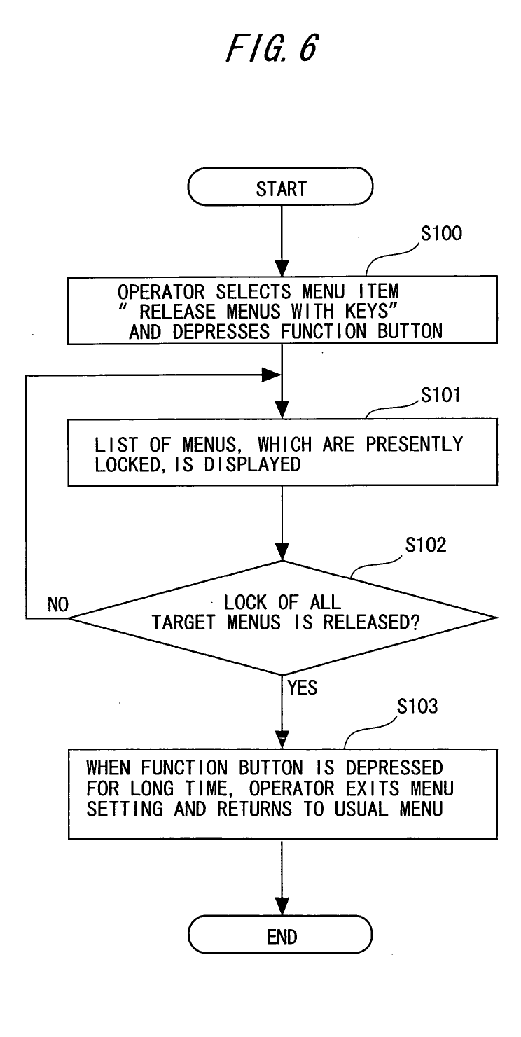

Next, an operation process for releasing lock of menu items will be explained on the basis of a flowchart in FIG. 6. As shown in FIG. 5, the release of lock in this embodiment is performed collectively by displaying only locked menu items on the display 2 as a list. Note that this processing is executed by an application that is stored in the ROM 12 and displays locked menu items as a list. Although not shown in the figure, this application is displayed as a menu item “release of menus with keys” in menu items to be displayed on the display 2.

In releasing lock for disabling execution of menu items, the operator selects this menu item “release of menus with keys” and depresses the function button 3b shown in FIG. 4 (S100). Then, the CPU 10 extracts the application, which displays the above locked menu items as a list, from the ROM 12 and executes the application. Consequently, only the locked menu items are displayed on the display 2 of the cellular phone 1 as a list (S101).

For this selection of the menu item, for example, the operator depresses the function button 3b for a short time. Here, the operator selects the menu item “release of menus with keys” for releasing lock. In response to this selected operation, the lock application 4 releases the lock of the selected menu item.

Then, the operator judges whether lock release processing for all the menu items has been performed (S102). Here, if there are menu items for which the lock has not been released yet, the operator returns to the processing for displaying the locked menu items as a list (step 101) again.

On the other hand, if the operator judges in step 102 that the lock of all the menu items is released, the operator depresses the function button 3b for a long time (S103). According to this operation, the CPU 10 performs the usual processing for displaying menu items.

Through such a process, it is possible to release a lock state of locked menu items.

As described above, according to the information apparatus of this embodiment, it is possible to continuously lock execution of menu items. Consequently, it is possible to eliminate complicated operation involved in lock setting work.

Similarly, it is possible to perform release of lock collectively after a list is displayed. Thus, it is possible to release the lock state promptly with simple operation.

In addition, according to execution of the notification application 5 of this embodiment, the operator can identify locked menu items clearly. Consequently, it is possible to sufficiently prevent the operator from performing disordered operation.

Note that, in the first embodiment described above, the method of displaying characters “key” for locked menu items as shown in the screen C in FIG. 4 is adopted as a method of notifying locked menu items. However, a notification method in the invention is not limited to the method.

(First Modification)

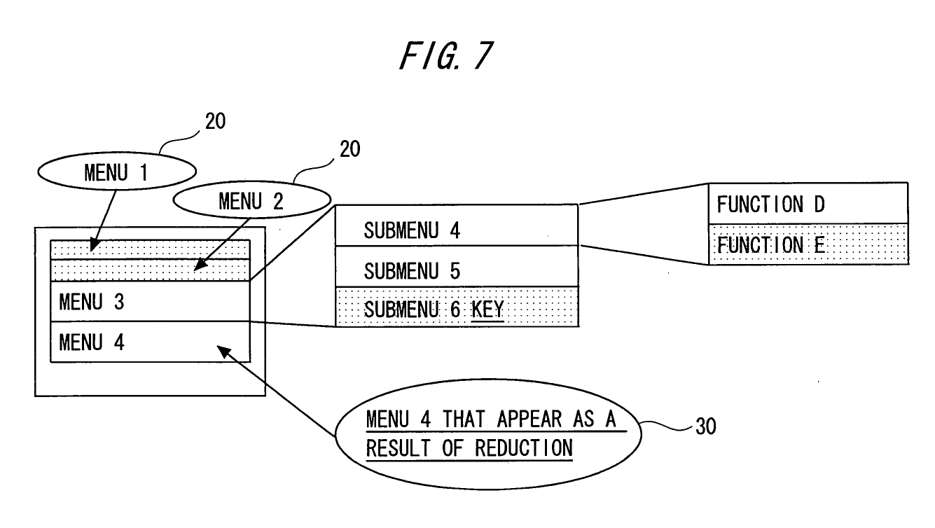

As shown in FIG. 7, the notification application 5 in the present invention may display locked menu items 20 with a size in a vertical direction thereof reduced to half a normal display size. Although not shown in the figure, other than this size, a size in a horizontal direction of the locked menu items 20 may be compressed to a quarter of the usual display size. Consequently, it is possible to arrange four locked menu items side by side in a space of a menu item displayed in a usual size.

Processing involved in this display is performed according to processing by the CPU 10. More specifically, the processing is realized by execution of an application (not shown) that is stored in the ROM 12 and, in response to lock of execution of a menu item, reduces the menu item. Consequently, it is possible to display a new menu item 30, which cannot be displayed simultaneously, on one screen.

(Second Modification)

The notification application 5 in the present invention may change a display color of locked menu item on the display 2. This processing is realized by execution of an application (not shown) that is stored in the ROM 12 and, in response to lock of execution of a menu item, changes setting for a display color of the menu item to a color different from a usual display color.

(Third Modification)

The notification application 5 in the present invention may display locked menu items in a size smaller than usual. For example, the notification application 5 may change brightness of locked menu items on the display 2 (not shown). This processing is realized by execution of an application (not shown) that is stored in the ROM 12 and, in response to lock of execution of a menu item, changes setting for display brightness of the menu item to be different from usual brightness. For example, locked menu items are displayed on the display 2 with brightness thereof set low (dark) or high (bright).

(Fourth Modification)

The notification application 5 in the present invention may display menu items, which are not locked, on the display 2 in a size larger than a usual size. This processing is realized by execution of an application (not shown) that is stored in the ROM 12 and, in response to lock of execution of a menu item, changes a display size of menu items other than the menu item to be larger than a usual display size.

### Second Embodiment

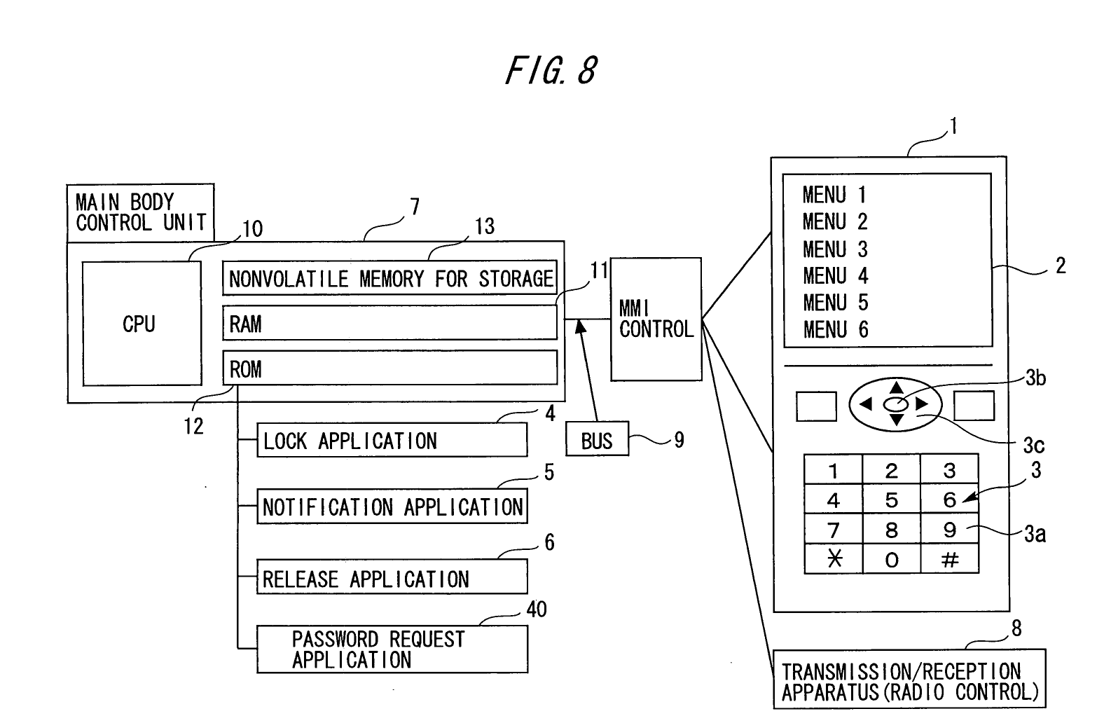

As shown in FIG. 8, the information apparatus 1 in this embodiment includes, in the information apparatus (the cellular phone 1) in the first embodiment described above, a password request application (requesting means) 40 that requests a password before locking a menu item. This password request application 40 is stored in the ROM 12 shown in FIG. 8. Note that a hardware structure of the information apparatus 1 in this embodiment is identical with that in the first embodiment except for the password request application 40. Thus, the identical components are denoted by reference numerals identical with those in the first embodiment, and explanations of the components are omitted.

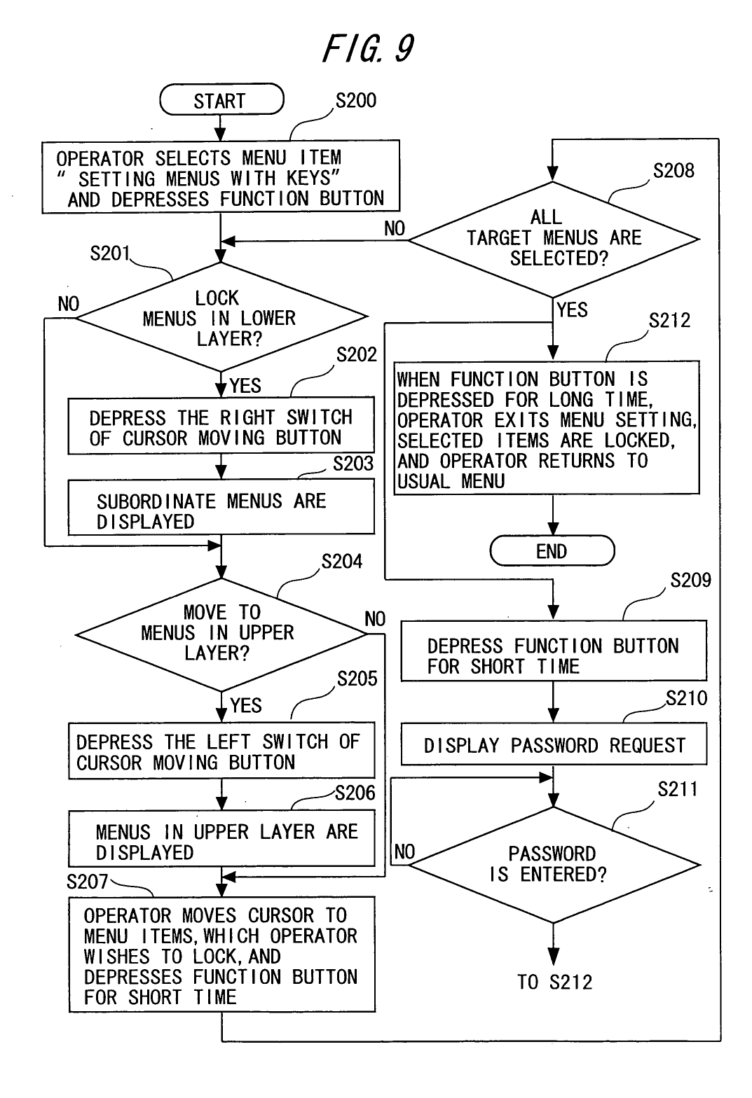

An operation process in this embodiment will be hereinafter explained on the basis of a flowchart shown in FIG. 9.

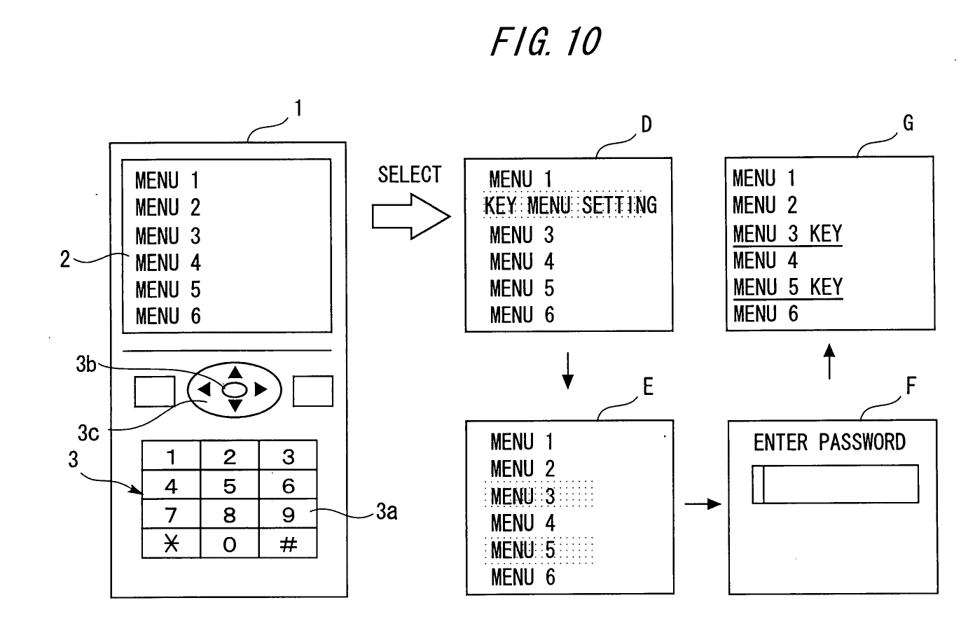

First, an operator selects a menu item “key menu setting” displayed on the display 2 of the cellular phone 1 as shown in a screen D in FIG. 10 and depresses the function button 3b (S200). At this point, the CPU 10 extracts the lock application 4, which disables execution of menu items, from the ROM 12 and executes the lock application 4.

Next, the operator selects whether menu items in a lower layer should also be locked (S201). Here, if the menu items in the lower layer are locked, the operator depresses the right switch of the cursor moving button 3c (S202). Then, the CPU 10 performs processing for displaying the menu items in the lower layer on the display 2. Consequently, the menu items in the lower layer are displayed on the display 2 (S203).

Next, the operator selects whether a cursor should be moved to menu items in an upper layer (S204). As regards this selection, for example, a case in which only lock for the menu items in the upper layer is performed and a case in which lock for the menu items in the lower layer is not performed may be assumed. Note that, when the operator decides in the step 202 that the menu items in the lower layer should not be locked, the process proceeds to step 204.

Here, when the operator wishes to move the cursor to the menu items in the upper layer, the operator depresses the left switch of the cursor moving button 3c (S205). At this point, in response to the depression of the cursor moving button 3c, the CPU 10 performs processing for displaying the menu items in the upper layer on the display 2. Consequently, the menu items in the upper layer (the screen D in FIG. 10) are displayed on the display 2 (S206).

On the other hand, when the cursor is not moved to the menu items in the upper layer in step 204, as shown in a screen E in FIG. 10, the operator moves the cursor to a menu item, which the operator wishes to lock, and depresses the function button 3b for a short time (S207). Note that lock setting for the menu items in the upper layer is performed in the same manner.

Here, when selection of all the menu items is not completed (S208), the process returns to step 201 to repeat the same processing.

On the other hand, when selection of all the menu items is completed (S208), the operator depresses the function button 3b for a short time (S209). In response to this operation, the CPU 10 executes the password request application 40. Then, as shown in a screen F in FIG. 10, a comment requesting the operator to enter a password is displayed on the display 2 (S210).

After entering the password (S211), the operator depresses the function button 3b for a long time (S212). At this point, the lock application 4 executes processing for disabling execution of the menu items selected with the cursor moving button 3c. Here, simultaneously with the setting for lock, the CPU 10 extracts the notification application 5 from the ROM 12 and executes the notification application 5.

When the locked menu items are displayed on the display 2, as shown in a screen G in FIG. 10, the notification application 5 performs processing for displaying characters “key” near the menu items.

Through the process described above, the lock setting for disabling execution of the menu items is performed.

It is possible to prevent lock setting due to careless operation, according to execution of the password request application 40 in this embodiment.

In addition, the password request application 40 in this embodiment may be executed in releasing a lock state of menu items.

Consequently, it is possible to prevent the lock from being released as a result of careless operation.

### INDUSTRIAL APPLICABILITY

The present invention can be used for a cellular phone and a portable apparatus.

<Others>

The disclosures of international application PCT/JP2003/001232, filed on Feb. 6, 2003 including the specification, drawings and abstract are incorporated herein by reference.

1. An information apparatus, comprising:
display unit sequentially displaying menu items that spread hierarchically and determine an operation content of the information apparatus;
selecting unit selecting the menu items; and
lock unit collectively disabling execution of plural menu items selected by the selecting unit.

2. An information apparatus according to claim 1, further comprising notifying unit notifying that execution of the menu items is disabled by the lock unit.

3. An information apparatus according to claim 1, further comprising requesting unit requesting a predetermined password before the lock unit disabling execution of plural menu items.

4. An information apparatus according to claim 1, wherein the notifying unit displays the menu items execution-disabled by the lock unit on the display unit in a size smaller than a usual display state.

5. An information apparatus according to claim 1, wherein the notifying unit marks the execution-disabled menu items displayed on the display unit.

6. An information apparatus according to claim 1, wherein the notifying unit changes display brightness of the execution-disabled menu items that are displayed on the display unit.

7. An information apparatus according to claim 1, wherein the notifying unit changes display color of the execution-disabled menu items that are displayed on the display means.

8. An information apparatus according to claim 1, wherein the notifying unit displays menu items other than the execution-disabled menu items that are displayed on the display unit in a size larger than a usual display size.

9. An information apparatus according to claim 1, wherein the display unit displays menu items locked by the lock unit on the display unit as a list.

10. An information apparatus according to claim 1, further comprising releasing unit releasing lock of menu items execution-disabled by the lock unit in an order of selection by the selecting unit.

11. An information apparatus according to claim 1, wherein the lock unit disables execution of the menu items by executing predetermined menu items.

12. A method comprising the step of:
sequentially displaying menu items that spread hierarchically and determine an operation content of the information apparatus;
selecting the menu items; and
disabling execution of selected plural menu items collectively.

13. A program that is capable of causing a computer to execute the step of:
sequentially displaying menu items that spread hierarchically and determine an operation content of the information apparatus;
selecting the menu items; and
disabling execution of selected plural menu items collectively.
